(19) United States
(12) Patent Application Publication
(10) Pub. No.: US 2020/0261316 A1
(43) Pub. Date: Aug. 20, 2020

(54) DEVICE AND METHOD FOR THE REHYDRATION AND UTILIZATION OF A DEHYDRATED LIQUID SUBSTANCE

(71) Applicant: OROFINO PHARMACEUTICALS GROUP SRL, Roma (IT)

(72) Inventor: Ernesto OROFINO, Roma (IT)

(73) Assignee: OROFINO PHARMACEUTICALS GROUP SRL, Roma (IT)

(21) Appl. No.: 16/644,906

(22) PCT Filed: Sep. 6, 2018
(86) PCT No.: PCT/IB2018/056796

§ 371 Date: Mar. 5, 2020

(30) Foreign Application Priority Data
Sep. 13, 2017 (IT) 102017000102375

(51) Int. Cl. A61J 1/20; A61J 11/04

(52) U.S. Cl. CPC A61J 1/2093; A61J 9/008; A61J 11/04

(57) ABSTRACT

A portable device may contain a liquid and a dehydrated substance, for example an edible substance, which can be mixed for rehydration. The portable device also includes a device for using the rehydrated substance. The method includes device operation steps to mix the substance and the liquid and at the same time prepare the device for using the rehydrated liquid substance. The device and method are especially adapted for use during daily trips.

The present invention relates to a device and method for rehydrating end utilizing a dehydrated liquid substance.

More precisely, the present invention relates to a device, for example portable, which can contain a liquid and a dehydrated substance, for example edible, which can be mixed at a certain point in time for rehydration. The device also comprises utilization (dispensing) means for utilization (dispensing) of the rehydrated substance. The method consists in operation phases of the device, so as to mix the substance and the liquid and at the same time prepare the utilization means of the rehydrated liquid substance. The device and method are specially adapted for use during daily trips.

### PRIOR ART

Dehydration is a common method for preserving perishable foods. For example, the shelf-life period of liquid milk has increased from a few weeks to several months, dehydrating the liquid milk to form powdered milk. Dehydrated substances are particularly useful when refrigeration is not available because dehydrated substances can be stored at room temperature. Naturally, when the dehydrated edible substances are re-hydrated by mixing them with a liquid, the shelf life of the rehydrated edible substance is typically equal to or less than that of the perishable food from which it was produced. Therefore, the hydration process should be postponed until the dehydrated substance and the liquid are mixed, i.e. immediately before consumption.

Devices are known which include separate compartments for storing the water and the dehydrated substance until the moment when it is decided to mix the two substances to have a re-hydrated edible substance. An example is the baby bottle described in the patent document U.S. Pat. No. 5,678,709, whose FIG. 4 is shown as FIG. 1 of the present description.

In this FIG. 1, it is noted that the baby bottle is in the classic configuration, with a bottle 210 and a nipple set 205 connected to the bottle, through an intermediate arrangement. The intermediate arrangement includes a hollow spherical container 223. Unscrewing the ring 250, it is possible to rotate the hollow spherical container 223 until an opening of the spherical container is positioned in line with the upper opening of the bottle 210. The powdered milk drops in the bottle and mixes with the water: by closing the ring 250, the baby bottle is obtained with the milk ready to be consumed.

However, this device has a number of drawbacks.

First of all, there is a transport problem, since the baby bottle is to be placed in another parallelepiped container for efficient storage.

Secondly, connector 250 and the other components described in the patent document are of such a nature as to be expensive and heavy, with a weight that is added to that of edible content.

Thirdly, the components and materials to be used increase the cost of the product to such an extent as to prevent mass marketing. For example, it is not possible to use the Tetrapak for the bottle of the prior art, for which the plastic is suggested instead.

### Purpose and Object of the Invention

The object of the present invention is to provide a portable device for rehydrating and consuming fluid edible substances, in particular provided with a nipple, which solves the problems and overcomes the disadvantages of the prior art.

It is an object of the present invention a device according to the attached claims, which form an integral part of the present description.

### DETAILED DESCRIPTION OF EXAMPLES OF EMBODIMENT OF THE INVENTION

### List of Figures

The invention will now be described by way of illustration but not by way of limitation, with particular reference to the drawings of the attached figures, in which:

FIG. 1 shows baby bottles according to the known art;

FIG. 2 shows an embodiment of the present invention, in a first operating state;

FIG. 3 shows the embodiment of FIG. 2, in a second operating state;

FIG. 4 shows the embodiment of FIG. 2, in a third operating state;

FIG. 5 shows the embodiment of FIG. 2, in a fourth operating state;

FIG. 6 shows the embodiment of FIG. 2, in a fifth operating state;

FIG. 7 shows the embodiment of FIG. 2, in a sixth and last operational state; and

FIG. 8 shows a detail of the nipple of the previous figures, in a position of use.

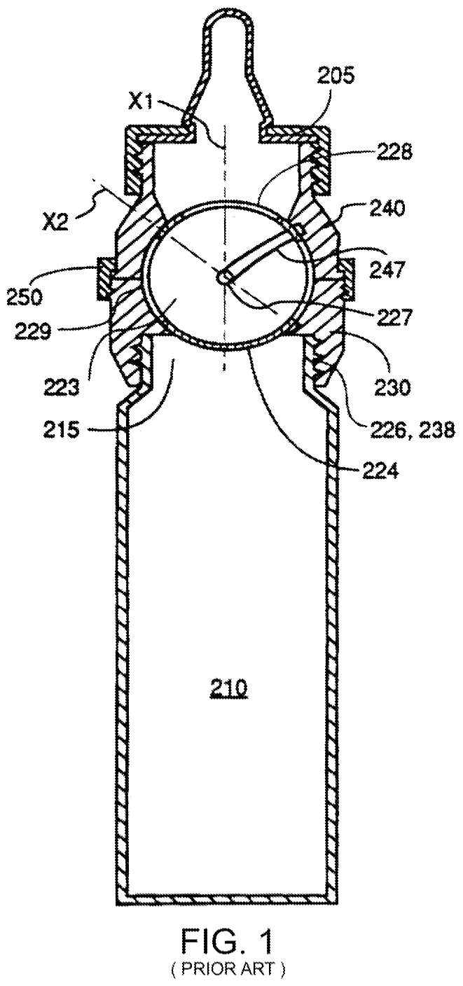

It is here specified that elements of different embodiments may be combined together to provide further embodiments without limits, respecting the technical concept of the invention, as the skilled person understands without problems from what is described.

The present description also refers to the prior art for its implementation, with regard to the characteristics of detail not described, such as elements of minor importance usually used in the prior art in solutions of the same type.

When an element is introduced, it always means that it can be “at least one” or “one or more”.

When listing a list of elements or features in this description it is meant that the solution according to the invention “comprises” or alternatively “is composed of” such elements.

In the following, “substance” means a single pure element or in combination in a compound. By “liquid” it is also meant a pure liquid, in particular water, or in a solution.

### Forms of Realization

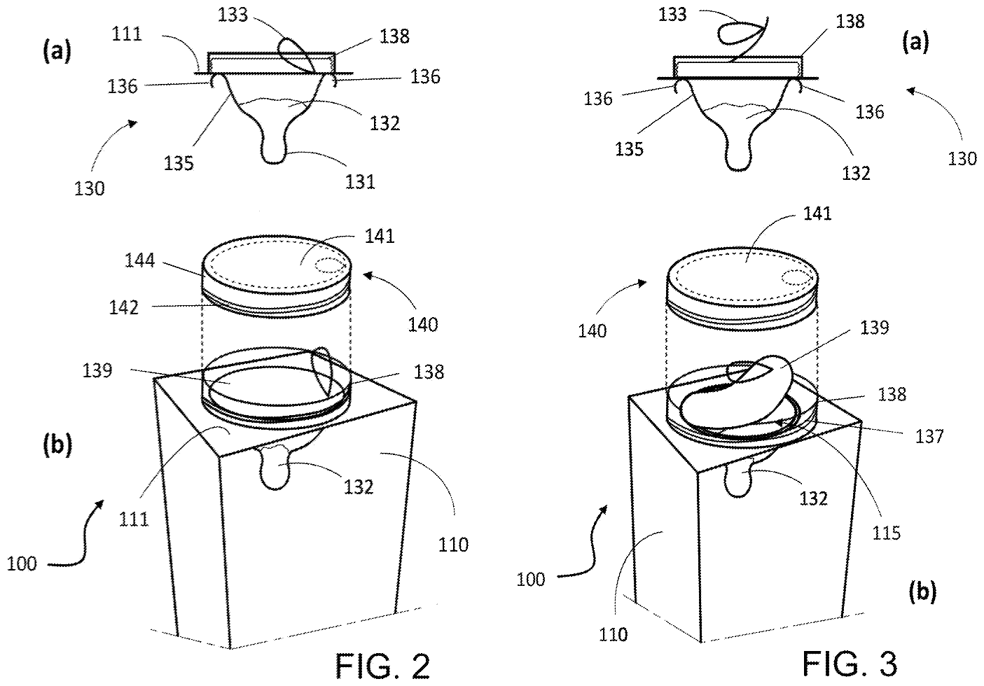

With reference to FIG. 2, in a first operating state the device 100 according to the invention comprises a liquid container 110, for example in the form of a parallelepiped such as the classic Tetrapak milk containers, with a cap or stopper 140 connected to it in a fixed way. The cap closes an opening 115 in the container in various ways, for example forming a closed volume around the opening. The opening is conveniently circular, but can also be square or with another shape.

The shape of the liquid container can be any, with flat or even curved walls. The liquid may be water or other solution suitable for rehydrating a dehydrated edible material.

The cap 140 closes an opening in the container 110 in which the utilization means 130 are inserted, which will serve for the use of the re-hydrated material once they have been brought out of the container 110 and suitably reconnected therefrom.

In particular, but not by way of limitation, the utilization means 130 consist of a nipple 135 with a tip 131. Inside the nipple there is a powder 132 which constitutes the dehydrated substance or food. Instead of the nipple, it is possible to provide, for example, suction means for adults, or means for pouring the rehydrated liquid, within the same inventive concept described herein with reference to the nipple example. The person skilled in the art will understand how to apply it to the various technical possibilities for use.

The nipple in general is a flared cavity, and according to the invention has a profile such that at the base (wider) has a circular end, in particular curved end 136, which will be useful for fixing in the operating position of use, as it will be illustrated in the following description.

The base above, as well as the opening 115, may also not be circular.

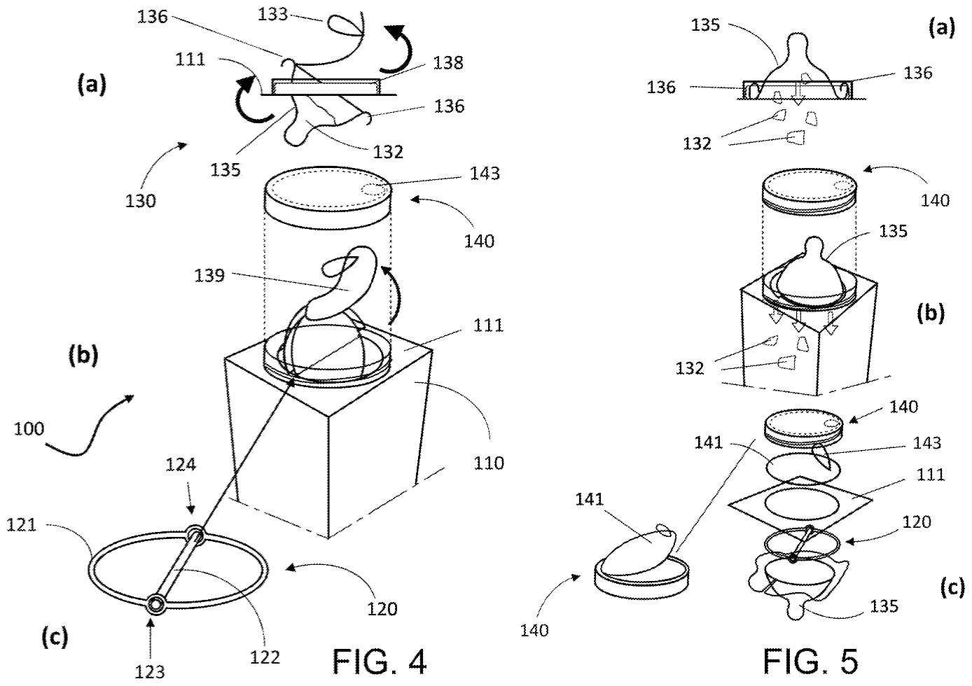

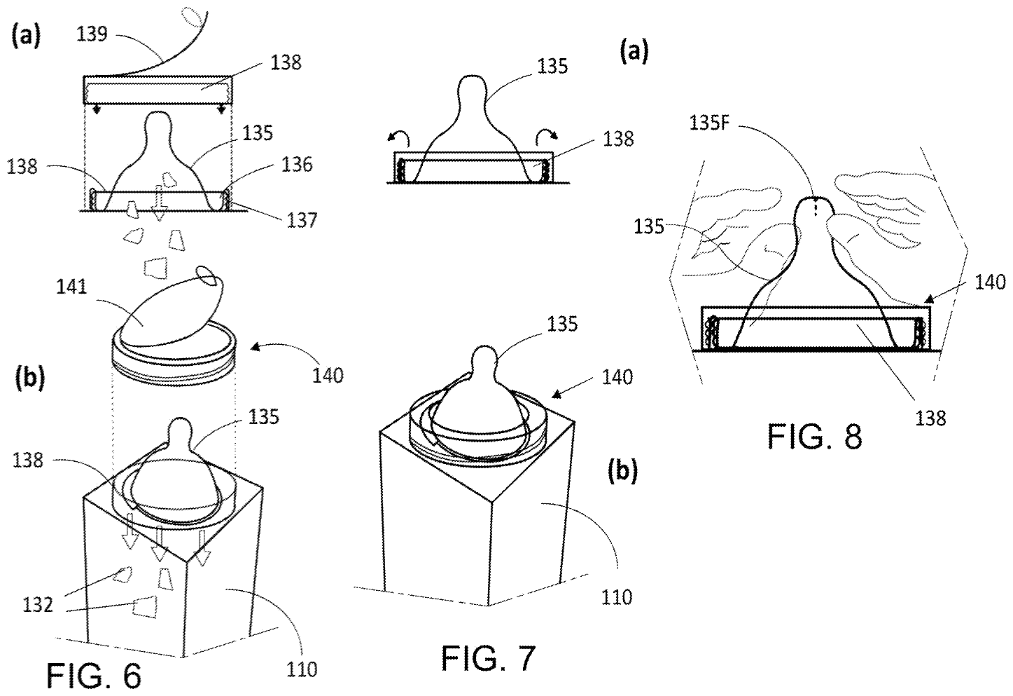

The nipple profile 135, 136 is fixed, for example by gluing on the bending portion of the curved part 136, to a removable or punctureable base 139 of the liquid container. Gripping means 133 may be connected to the removable or perforable base 139, for example in the form of an eyelet-configured thread. By manually pulling the gripping means 133, the disc 139 is torn away, as shown in FIGS. 3 and 4.

To the other side of liquid container 110 wall 111, a closing element 138 is fixed, which substantially surrounds the opening 115. This closing element 138, according to an aspect of the invention, is a wall, advantageously cylindrical, with open bases and substantially perpendicular to the wall 111 of the container. This wall 138 is provided with a thread 137 referenced in FIG. 3.

Again with reference to FIGS. 2 and 3, the device according to the invention is completed by means for closing the device 100 constituted, by way of example, by a circular cap 140, which has an internal thread 142 corresponding to the thread 137 of the wall 138, in such a way that the cap 140 can be screwed onto the wall 138. The device 100 in the closed configuration of FIG. 2 is adapted to be efficiently stored and transported, and may be made of materials different from the molded plastics, for example in Tetrapak.

FIG. 3 shows the removal of the base 139 while FIG. 4 shows the rotation of the nipple 135 to bring it outside the container 110. For this purpose, the device according to the invention is provided with rotation means 120 fixed to the container 110 on the edge of the aforesaid opening 115. For example, the rotation means 120 consist of a ring 121 fixed to the base of the nipple and rotatable about a fixed axis 122 which diametrically crosses the aforesaid opening of the container 110. The axis can also be absent if there are at least two diametrically opposite pins connected to the opening.

In FIG. 5 the nipple is outside the container 110, and then the dried (dehydrated) content 132 falls inside the same container 110 and is then rehydrated. As shown in (c), the cap 140 comprises the tearable or peelable or perforable circular surface 141, also optionally provided with gripping means 143. This peelable surface 141 provides, in the closed state of the device 100, a further closure of the device itself. When the nipple 135 is rotated outwardly, the peel-off surface 141 must be removed (or perforated) in order to allow the nipple 135 to pass inside the cap 140, which is to be screwed to the outer wall of the closing element 138. In this way, the cap becomes a fastening element of the nipple 135.

In order to better ensure the fixed and hold positioning of the nipple 135, the curved ends 136 can be folded over the thread 137 so that they are locked by screwing the cap 140 with the peel-off surface 141 removed.

Finally, referring to FIG. 8, once the nipple 135 has been fixed, a slight pressure may be applied to open the pre-cut hole 135F. At this point, re-hydrated content can be used.

In this way, a real baby bottle has been obtained, and, in the most general form, a container of a re-hydrated liquid with utilization means connected to it.

It is understood that this device is portable and can be used in everyday life even on a journey or on the road, making it pass from the closed state to the utilization state according to the steps described and illustrated above.

Although embodiments have been described in which the rehydrated content is edible, it is conceivable to obtain a non-edible content associated with the utilization means such as a pouring spout, means which skilled person can provide without effort.

### Advantages of the Invention

The device according to the invention has a number of advantages.

First of all, it is suitable for storage and transport, since, in its closed state, it has a substantially parallelepiped shape.

Secondly, it has a very simple structure that does not make it heavy.

Thirdly, food materials different from molded plastics can be used, such as Tetrapak.

These and other advantages allow mass marketing.

These advantages will be noted in particular with respect to the device of the aforementioned patent document U.S. Pat. No. 5,678,709, in which it is clear that the container of the powder substance is separated from the use means.

Moreover, with the device and method according to the invention, the dose of milk to be administered to the infant will never be mistaken, the error of which sometimes causes intestinal problems such as diarrhea. In fact the powder content is predetermined.

Preferred embodiments and possible variations of the invention have been described above, but it is to be understood that the skilled person may make modifications and changes without falling outside the scope of protection, as defined in the attached claims.

1) Device, comprising:
a liquid container having an opening,
a cap for closing said opening,
a substance container for containing a dehydrated substance, and
a dispenser for dispensing the liquid once mixed with the dehydrated substance,
said substance container having a flared cavity with a narrower end opposite to an open base, the open base being closed by a removable or perforable cover;
said dispenser comprising said substance container, wherein said narrower end has an end hole;
said substance container being connected to said opening by a rotator, wherein the rotator is configured to rotate the substance container from one side to the other of said opening; and
said cap having a substantially perimetrically closed wall with an upper perimeter closed by a further removable or perforable cover and with an open lower perimeter;
a closure element is attached to said liquid container around said opening, the closure element being configured to connect to said wall on the side of the open lower perimeter.

2) Device according to claim 1, wherein said substance container comprises a baby's bottle nipple.

3) The device according to claim 2, wherein the narrower end is the suction tip of the baby's bottle nipple and the end hole comprises a pre-cut hole openable by manual pressure.

4) Device according to claim 1, wherein said closure element has a closure element thread configured to couple with a thread on the wall of the cap.

5) Device according to claim 4, wherein said open base of said flared cavity has a flap, which is foldable, when the flared cavity is rotated out of the liquid container, onto said closure element thread.

6) Device according to claim 1, wherein the rotator comprises a ring rotatably engaged in two diametrically opposed points of said opening.

7) Device according to claim 6, wherein said ring is rotatably engaged with an axis placed across said opening.

8. Device according to claim 1, wherein said removable or perforable cover and/or said further removable or perforable cover comprise respective grips configured for manual removal.

9. Device according to claim 1, wherein said liquid container is made of Tetrapak.

10. Method for rehydrating a dehydrated substance, the method using the device according to claim 1, the method comprising the following steps:
A. providing the device, with said substance container inside the liquid container and said wall coupled to said closure element;
B. decoupling said wall from said closure element;
C. removing or perforating said removable or perforable cover;
D. rotating said substance container to bring the substance container out of said liquid container;
E. removing or perforating said further removable or perforable cover;
F. coupling the wall again with the closure element;
G. opening said narrower end by the end hole.

11. Method according to claim 10, wherein the following step is carried out between step D and step F,
H. folding said flap onto said closure element.
